(19) United States
(12) Patent Application Publication
(10) Pub. No.: US 2026/0140404 A1
(43) Pub. Date: May 21, 2026

(54) OPTICAL DEVICE WITH BENDING WAVEGUIDES

(71) Applicant: Taiwan Semiconductor Manufacturing Company, Ltd., Hsinchu (TW)

(72) Inventors: Chia-Wei CHIANG, Hsinchu (TW); Sheng Kai YEH, Hsinchu (TW); Lian Wee LUO, Hsinchu (TW); Chi-Yuan SHIH, Hsinchu (TW); Chun-Pei WU, Hsinchu (TW); Tse-En CHANG, Hsinchu (TW)

(73) Assignee: Taiwan Semiconductor Manufacturing Company, Ltd., Hsinchu (TW)

(21) Appl. No.: 18/955,431

(22) Filed: Nov. 21, 2024

(51) Int. Cl. G02F 1/025

(52) U.S. Cl. CPC G02F 1/025

(57) ABSTRACT

An optical device for optical modulation is provided. The optical device includes a splitter configured to split an input optical signal into a first optical signal and a second optical signal, and a phase shifter including a first waveguide arm and a second waveguide arm. Each of the first waveguide arm and the second waveguide arm includes a plurality of bending waveguides coupled in series, and the phase shifter is configured to generate a phase difference between the first optical signal in the first waveguide arm and the second optical signal in the second waveguide arm. The optical device further includes a combiner configured to combine the first optical signal and the second optical signal to generate a modulated output signal.

### BACKGROUND

Optical devices, such as optical modulators or phase shifters are very promising for providing a high data transmission rate, an ultra-low power consumption, and a small footprint (or size) for high-speed data communication systems. An electro-optic modulator (EOM) is a signal-controlled element exhibiting an electro-optic effect that is used to modulate an optical signal. A Mach-Zehnder modulator (MZM) is a phase-modulating EOM used as an amplitude modulator by using a Mach-Zehnder interferometer (MZI). However, the long straight waveguide used in each waveguide arm takes up a lot of space and induces uncontrolled phase mismatch. As such, advances in the field of forming a modulator are necessary to reduce the overall size of the optical device. Further improvements are needed in order to meet the desired design criteria such that high-speed data communication for optical devices may be maintained.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1A illustrates a diagram of an optical device for optical modulation, according to embodiments of the present disclosure.

FIG. 1B illustrates a diagram of bending waveguides, according to embodiments of the present disclosure.

FIG. 2 illustrates a diagram of a close-up view of a bending waveguide, according to embodiments of the present disclosure.

FIG. 3A illustrates a diagram of a cross-section view of a bending waveguide, according to embodiments of the present disclosure.

FIG. 3B illustrates a diagram of a cross-section view of a bending waveguide, according to embodiments of the present disclosure.

FIG. 4 illustrates a diagram of an energy distribution of the optical signal in a bending waveguide, according to embodiments of the present disclosure.

FIG. 5 illustrates a diagram of a close-up view of a bending waveguide, according to embodiments of the present disclosure.

FIG. 6 illustrates a diagram of a close-up view of a bending waveguide, according to embodiments of the present disclosure.

FIG. 7 illustrates a diagram of a cross-section view of a bending waveguide, according to embodiments of the present disclosure.

FIG. 8 illustrates a process flow of operating an optical device, according to embodiments of the disclosure.

### DETAILED DESCRIPTION

It is to be understood that the following disclosure provides many different embodiments, or examples, for implementing different features of the disclosure. Specific embodiments or examples of components and arrangements are described below to simplify the present disclosure. These are, of course, merely examples and are not intended to be limiting. For example, dimensions of elements are not limited to the disclosed range or values, but may depend upon process conditions and/or desired properties of the device. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Various features may be arbitrarily drawn in different scales for simplicity and clarity.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 90 degrees or at other orientations) and the spatially relative descriptors used herein may likewise be interpreted accordingly. In addition, the term “made of” may mean either “comprising” or “consisting of.”

Traveling wave Mach-Zehnder modulators (TWMZMs) are used for signal modulation for optical signals and waveguides with P/N junctions. However, the long straight waveguide used in each of the waveguide arms takes up a lot of space and induces uncontrolled phase mismatch between the waveguide arms. In addition, the parasitic resistance and the capacitance of the waveguides also affect the performance of the traveling wave Mach-Zehnder modulators. In some examples, the parasitic resistance is reduced by increasing the thickness of the slab and the implant concentration. However, optical losses will increase and the optical mode confinement will degrade by increasing the thickness of the slab or the implant concentration. Embodiments of this disclosure provide an optical device with bending waveguides, thereby reducing the parasitic resistance without degrading the optical mode confinement. For example, a modulator having a phase shifter that modulates the optical signal by using bending waveguides with P/N junctions improves the modulation efficiency and reduces the signal loss during the modulation. In some examples, the bending waveguides reduce the parasitic resistance and overall size of the modulator without causing optical loss or optical mode confinement issues. As a result, the modulation of optical signals can be improved, thereby enabling high-speed data communication for optical devices.

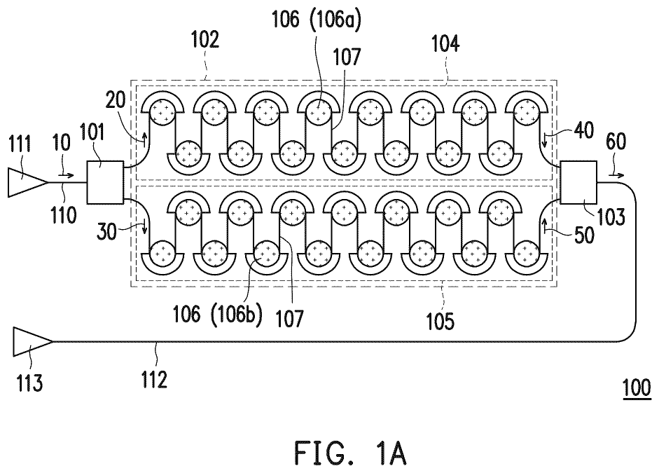

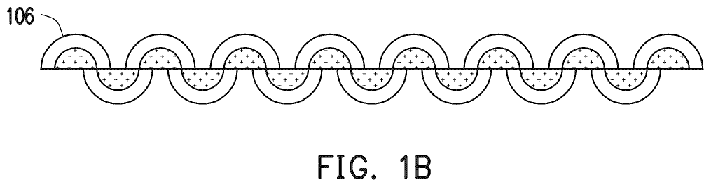

FIG. 1A illustrates a diagram of an optical device 100 for optical modulation, according to embodiments of the present disclosure.

In some embodiments, as shown in FIG. 1A, the optical device 100 includes a splitter 101, a phase shifter 102, and a combiner 103. In some embodiments, the splitter 101, the phase shifter 102, and the combiner 103 are coupled and/or connected in series sequentially to transmit an input optical signal 10 and output an output signal 60. In one embodiment, the splitter 101, the phase shifter 102, and the combiner 103 are formed based on silicon-on-insulator (SOI) technology, i.e. including a silicon-insulator-silicon structure, where the insulator may be a buried oxide layer.

In some embodiments, the splitter 101 is an optical splitter configured to split the input optical signal 10 into a first optical signal 20 and a second optical signal 30. In some examples, the optical power of the input optical signal 10 is equally divided between the first optical signal 20 and the second optical signal 30. In some examples, a splitting ratio of the optical power of the first optical signal 20 to the second optical signal 30 is 1:2, 1:4, 1:8, or 1:16. In some examples, the splitting ratio of the first optical signal 20 to the second optical signal 30 is 2:1, 4:1, 8:1, or 16:1. In some examples, the splitting ratio of the optical power of the input optical signal is any suitable number.

In some embodiments, the phase shifter 102 is coupled and connected to the splitter 101 to transmit the first optical signal 20 and the second optical signal 30 into the phase shifter 102. The phase shifter 102 includes a first waveguide arm 104 and a second waveguide arm 105. The phase shifter 102 is configured to generate a phase shift between the first optical signal 20 in the first waveguide arm 104 and the second optical signal 30 in the second waveguide arm 105 in some embodiments.

In some embodiments, the first waveguide arm 104 is configured to receive and transmit the first optical signal 20. In some embodiments, the first waveguide arm 104 is configured to control a first phase shift of the first optical signal 20. In some embodiments, the first waveguide arm 104 is configured to output a first phase-shifted optical signal 40 to the combiner 103.

In some embodiments, the second waveguide arm 105 is configured to receive and transmit the second optical signal 30. In some embodiments, the second waveguide arm 105 is configured to control a second phase shift of the second optical signal 30. In some embodiments, the second waveguide arm 105 is configured to output a second phase-shifted optical signal 50 to the combiner 103.

In some embodiments, each of the first waveguide arm 104 and the second waveguide arm 105 includes a plurality of bending waveguides 106 coupled and/or connected in series. For example, the first waveguide arm 104 includes a plurality of bending waveguides 106a coupled in series, and the second waveguide arm 105 includes a plurality of bending waveguides 106b coupled and/or connected in series. In some embodiments, the plurality of bending waveguides 106a in the first waveguide arm 104 are alternately oriented with convex sides facing each other in opposite directions. In some embodiments, the plurality of bending waveguides 106a in the first waveguide arm 104 are arranged along a substantially straight line. Similarly, in some embodiments, the plurality of bending waveguides 106b in the second waveguide arm 105 are alternately oriented with convex sides facing each other in opposite directions. In some embodiments, the plurality of bending waveguides 106b in the second waveguide arm 105 are also arranged along a substantially straight line. Although fifteen bending waveguides 106a, 106b are shown in each waveguide arm 104, 105, any suitable number of bending waveguides can be included in each waveguide arm. In some embodiments, there are fewer than fifteen bending waveguides 106a, 106b or more than fifteen bending waveguides 106a, 106b in each waveguide arm 104, 105.

The structure of the phase shifter 102 is much more compact than a phase shifter with two straight waveguides, and therefore the area required for the phase shifter 102 and the footprint of the optical device 100 are greatly reduced.

In some embodiments, each of the first waveguide arm 104 and the second waveguide arm 105 includes a plurality of straight waveguides 107. In some embodiments, adjacent bending waveguides of the plurality of bending waveguides 106a of the first waveguide arm 104 are coupled and/or connected with each other through a corresponding straight waveguide of the plurality of straight waveguides 107. Similarly, in some embodiments, adjacent bending waveguides of the plurality of bending waveguides 106b of the second waveguide arm 105 are coupled and/or connected with each other through a corresponding straight waveguide of the plurality of straight waveguides 107.

FIG. 1B illustrates a diagram of bending waveguides, according to embodiments of the present disclosure.

In some embodiments, each of the plurality of straight waveguides 107 is very short, such that opposing bending waveguides of the plurality of bending waveguides 106 are adjacent to each other. In some embodiments, the opposing bending waveguides of the plurality of bending waveguides 106 are coupled directly to each other without a straight waveguide 107 connecting them or with only a very short straight waveguide 107 portion, as illustrated in FIG. 1B. In some embodiments, each of the waveguide arms 104, 105 include the directly connected bending waveguides shown in FIG. 1B.

In some embodiments, the first waveguide arm 104 and the second waveguide arm 105 are symmetric to each other, except that the plurality of bending waveguides 106a and the plurality of bending waveguides 106b have different doping concentrations to provide the phase shift between the first optical signal in the first waveguide arm 104 and the second optical signal 30 in the second waveguide arm 105.

In some embodiments, the first waveguide arm 104 and the second waveguide arm 105 are symmetric to each other. The phase shift between the first optical signal 20 in the first waveguide arm 104 and the second optical signal 30 in the second waveguide arm 105 is provided by applying a bias voltage on at least one of the plurality of bending waveguides 106.

In some embodiments, the combiner 103 is configured to combine the first phase-shifted optical signal 40 and the second phase-shifted optical signal 50 to generate the output signal 60. In some embodiments, the combiner 103 is directly coupled and/or connected to the phase shifter 102 to combine the first phase-shifted optical signal 40 and the second phase-shifted optical signal 50. In some embodiments, the output signal 60 is controlled and/or modulated by the phase shifter 102.

In some embodiments, as shown in FIG. 1A, the optical signal 10 is coupled and/or transmitted to the splitter 101 from an optical source (not shown) through a first grating coupler 111 and a first waveguide 110 sequentially. In some embodiments, the output signal 60 is coupled and/or transmitted to an optical detector (not shown) through a second waveguide 112 and a second grating coupler 113 sequentially.

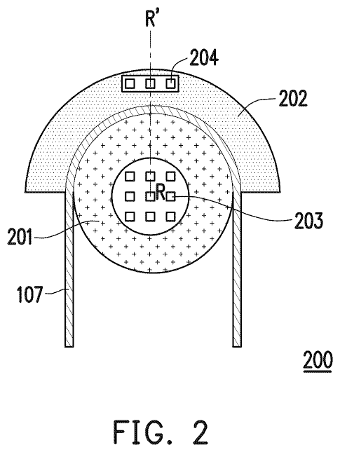

FIG. 2 illustrates a diagram of a close-up view of a bending waveguide 200, according to embodiments of the present disclosure. The bending waveguide 200 described herein corresponds to any of the plurality of bending waveguides 106 of the optical device 100 as described in FIG. 1A.

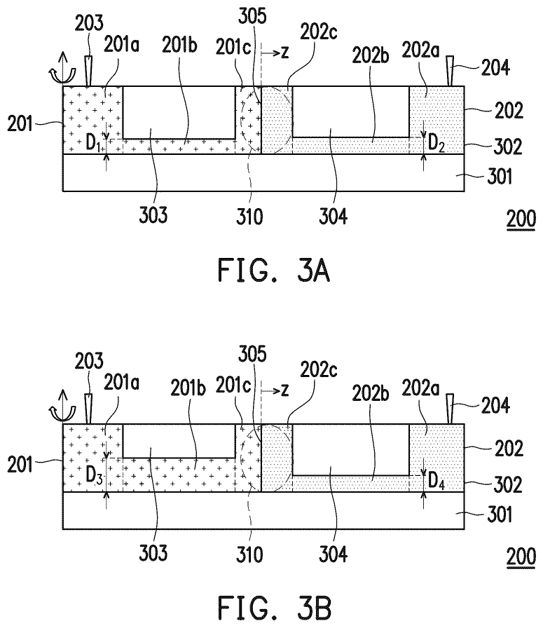

FIG. 3A illustrates a diagram of a cross-section view of the bending waveguide 200 along line R-R′ of FIG. 2, according to embodiments of the present disclosure.

In some embodiments, as shown in FIG. 2, the bending waveguide 200 is a ridge waveguide which includes a first doped portion 201 and a second doped portion 202 to form a P/N junction. In some embodiments, the first doped portion 201 is positioned inside of a concave curvature of the bending waveguide 200 and the second doped portion 202 is positioned outside of the concave curvature of the bending waveguide 200.

In some embodiments, as shown in FIG. 3A, the bending waveguide 200 further includes a first electrical contact 203 on the first doped portion 201 and a second electrical contact 204 on the second doped portion 202. In some embodiments, a bias voltage is applied through the first electrical contact 203 and the second electrical contact 204 to the P/N junction. The bias voltage is applied to the P/N junction, such that a depletion region forms within the bending waveguide 200. The size of the depletion region changes when the bias voltage changes, thereby changing the effective refractive index of the bending waveguide 200 and the phase shift between the first optical signal 20 in the first waveguide arm 104 and the second optical signal 30 in the second waveguide arm 105. The control of the phase shift between the first optical signal 20 in the first waveguide arm 104 and the second optical signal 30 in the second waveguide arm 105 modulates the output signal 60. In some embodiments, the bias voltage is in a range from about 0 volts to about 0.7 volts. In some embodiments, the bias voltage is in a range from greater than 0 volts to about 0.3 volts.

In some embodiments, when the phase shift between the first optical signal 20 in the first waveguide arm 104 and the second optical signal 30 in the second waveguide arm 105 is 180° (or an odd number times of 180°), the first phase-shifted optical signal 40 and the second phase-shifted optical signal 50 are destructively interfered. In some embodiments, when the phase shift between the first optical signal 20 in the first waveguide arm 104 and the second optical signal 30 in the second waveguide arm 105 is 360° (or an even number times of 180°), the first phase-shifted optical signal 40 and the second phase-shifted optical signal 50 are constructively interfered.

In some embodiments, the bending waveguide 200 is a portion of a circular waveguide. In some embodiments, the bending waveguide 200 is any suitable curved waveguide that is not necessarily circular shaped. Such suitable curved waveguides do not have sharp corners and/or other features that can cause relatively high optical losses in some embodiments. In some embodiments, a radius of the circular waveguide ranges from about 1 μm to about 30 μm. If the radius of the circular waveguide is too small, signal loss increases as a result of a number of reflections as the optical signal propagates through the circular waveguide, in some instances. If the radius of the circular waveguide is too large, the overall size of the bending waveguide increases without an appreciable increase in performance, in some instances. Although the first doped portion 201 is shown as circular in FIG. 2, the first doped portion is not limited to a circular shape, other suitable shapes are included within the scope of this disclosure, such as substantially semi-circular as shown in FIG. 1B.

In some embodiments, the bending waveguide 200 includes an oxide layer 301 and a semiconductor layer 302 on the oxide layer 301. In some examples, the oxide layer 301 is a silicon oxide layer. In some examples, the semiconductor layer 302 is a silicon layer, a germanium layer, or a silicon germanium layer.

In some embodiments, as shown in FIG. 3A, the semiconductor layer 302 includes the first doped portion 201 and the second doped portion 202 to form the P/N junction at an interface 305 between the first doped portion 201 and the second doped portion 202.

In some embodiments, the first doped portion 201 has a first dopant type and the second doped portion 202 has a second dopant type. The first dopant type is opposite to the second dopant type. In some examples, the first doped portion 201 has an n-type dopant and the second doped portion 202 has a p-type dopant. Alternatively, in some examples, the first doped portion 201 has a p-type dopant and the second doped portion 202 has an n-type dopant. In some embodiments, the n-type dopant is phosphorus, arsenic, and/or antimony. In some embodiments, the p-type dopant is boron, indium, and/or gallium.

In some embodiments, the bending waveguide 200 further includes a first isolation layer 303 formed in a first trench of the first doped portion 201. In some embodiments, the first isolation layer 303 is a shallow trench isolation (STI) layer. The first isolation layer 303 prevents electric current leakage between the first doped portion 201 and adjacent other semiconductor device components (not shown). In some embodiments, the first isolation layer 303 is made of silicon oxide and/or silicon nitride.

In some embodiments, the first doped portion 201 includes a no-pickup section 201a, a waveguide section 201c, and a slab section 201b positioned between the no-pickup section 201a and the waveguide section 201c.

In some embodiments, the bending waveguide 200 further includes a second isolation layer 304 formed in a second trench of the second doped portion 202. In some embodiments, the second isolation layer 304 is a shallow trench isolation (STI) layer. The second isolation layer 304 prevents electric current leakage between the second doped portion 202 and adjacent other semiconductor device components (not shown).

In some embodiments, the second doped portion 202 includes a no-pickup section 202a, a waveguide section 202c, and a slab section 202b positioned between the no-pickup section 202a and the waveguide section 202c.

In some embodiments, a thickness D₁ of the slab section 201b is less than a thickness of the no-pickup section 201a and a thickness of the waveguide section 201c. In some embodiments, a thickness D₂ of the slab section 202b is less than a thickness of the no-pickup section 202a and a thickness of the waveguide section 202c. In some embodiments, a ratio between the thickness D₁ of the slab section 201b and the thickness of the no-pickup section 201a is in a range from about 0.01 to about 0.99, and the ratio is in a range of from about 0.1 to about 0.5 in other embodiments. In some embodiments, a ratio between the thickness D₂ of the slab section 202b and the thickness of the no-pickup section 202a is in a range from about 0.01 to about 0.99, and the ratio is in a range of from about 0.1 to about 0.5 in other embodiments.

In some embodiments, the thickness D₂ of the slab section 202b is substantially equal to the thickness D₁ of the slab section 201b.

In some embodiments, the first isolation layer 303 is formed on the slab section 201b of the first doped portion 201. In some embodiments, the second isolation layer 304 is formed on the slab section 202b of the second doped portion 202.

In some embodiments, the waveguide section 201c of the first doped portion 201 and the waveguide section 202c of the second doped portion 202 form a ridge for the ridge waveguide. In some embodiments, the P/N junction is formed by the waveguide section 201c of the first doped portion 201 and the waveguide section 202c of the second doped portion 202. In some embodiments, as shown in FIG. 3A, the P/N junction is located at the center of the bending waveguide 200. In some embodiments, the location of the P/N junction is offset from the center of the bending waveguide 200. In some embodiments, the bending waveguide 200 has a fixed width.

An optical mode 310 in the bending waveguide 200 shifts in a direction z towards an outside of the concave curvature of the bending waveguide 200. For example, as shown in FIG. 3A, the optical mode 310 shifts away from an interface 305 between the first doped portion 201 and the second doped portion 202 in the direction z towards the outside of the concave curvature of the bending waveguide 200.

FIG. 3B illustrates a diagram of a cross-section view of the bending waveguide 200 along line R-R′ of FIG. 2, according to embodiments of the present disclosure. Components of the bending waveguide 200 described herein are similar to the components of the bending waveguide 200 as described in FIG. 3A, except that a thickness D₃ of the slab section 201b is different from the thickness of the thickness D₁ of the slab section 201b of FIG. 3A and a thickness D₄ of the slab section 202b is different from the thickness of the thickness D₂ of the slab section 202b of FIG. 3A.

In some embodiments, as shown in FIG. 3B, a thickness D₃ of the slab section 201b is less than a thickness of the no-pickup section 201a and a thickness of the waveguide section 201c. In some embodiments, a thickness D₄ of the slab section 202b is less than a thickness of the no-pickup section 202a and a thickness of the waveguide section 202c. In some embodiments, a ratio between the thickness D₃ of the slab section 201b and the thickness of the no-pickup section 201a is in a range from about 0.01 to about 0.99, and the ratio is in a range of from about 0.1 to about 0.5 in other embodiments. In some embodiments, a ratio between the thickness D₄ of the slab section 202b and the thickness of the no-pickup section 202a is in a range from about 0.01 to about 0.99, and the ratio is in a range of from about 0.1 to about 0.5 in other embodiments.

In some embodiments, as shown in FIG. 3B, the thickness D₄ of the slab section 202b is less than the thickness D₃ of the slab section 201b. The asymmetric bent hybrid slabs reduce the parasitic resistance of the phase shifter 102, thereby improving the modulation efficiency of the optical device and reducing the signal loss during the modulation.

As shown in FIG. 3B, when the optical mode 310 in the bending waveguide 200 shifts in a direction z towards an outside of the concave curvature of the bending waveguide 200, the thickness D₄ of the slab section 202b can be increased without causing any additional optical loss to the optical mode 310. As a result, the parasitic resistance of the bending waveguide 200 may be reduced without causing any optical loss or optical mode confinement issue.

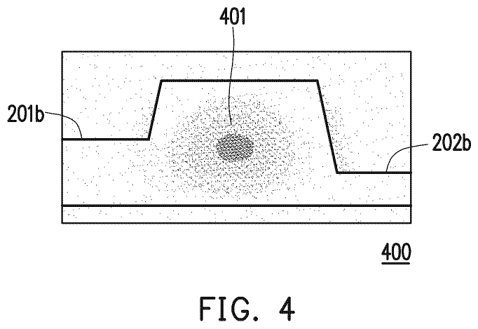

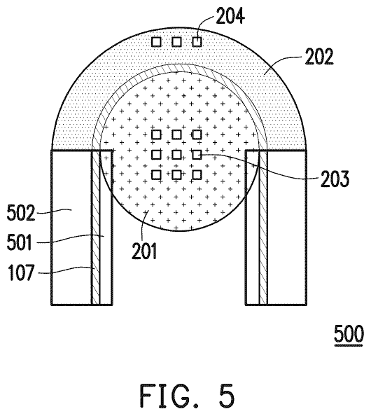

FIG. 4 illustrates a diagram of an energy distribution of the optical signal in the bending waveguide 200 of FIG. 3B, according to embodiments of the present disclosure.

In some embodiments, as shown in FIG. 4, a simulated energy distribution 401 of the optical signal is confined between the slab section 201b of the first doped portion 201 and the slab section 202b of the second doped portion 202. In other words, when the thickness of the slab section 201b of the first doped portion 201 is increased to be greater than the thickness of the slab section 202b of the second doped portion 202, the energy of the optical signal is still confined between the slab section 201b of the first doped portion 201 and the slab section 202b of the second doped portion 202 and the optical loss of the optical signal is prevented.

FIG. 5 illustrates a diagram of a close-up view of a bending waveguide 500, according to embodiments of the present disclosure. The bending waveguide 500 described herein corresponds to any of the plurality of bending waveguides 106 of the optical device 100 as described in FIG. 1A. Components of the bending waveguide 500 described herein are similar to the components of the bending waveguide 200 as described in FIG. 2,

In addition, in some embodiments, as shown in FIG. 5, each of the plurality of straight waveguides 107 includes a third doped portion 501 and a fourth doped portion 502. In some embodiments, the third doped portion 501 and the fourth doped portion 502 form a P/N junction. The third doped portion 501 and the fourth doped portion 502 provide an additional phase shift between the first optical signal 20 in the first waveguide arm 104 and the second optical signal 30 in the second waveguide arm 105 to improve the phase shift efficiency of the phase shifter 102.

In some embodiments, the third doped portion 501 has a same dopant type as the first doped portion 201. In some embodiments, the fourth doped portion 502 has a same dopant type as the second doped portion 202. In some examples, the third doped portion 501 and the first doped portion 201 have a p-type dopant, and the fourth doped portion 502 and the second doped portion 202 have an n-type dopant. Alternatively, in some examples, the third doped portion 501 and the first doped portion 201 have an n-type dopant, and the fourth doped portion 502 and the second doped portion 202 have a p-type dopant. In some embodiments, the n-type dopant is phosphorus, arsenic, and/or antimony. In some embodiments, the p-type dopant is boron, indium, and/or gallium.

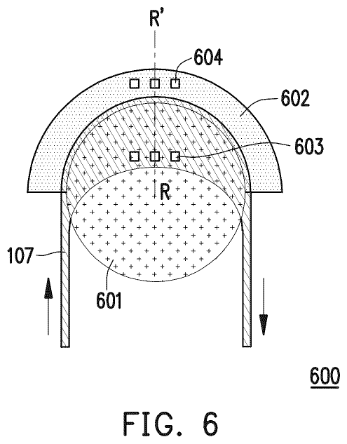

FIG. 6 illustrates a diagram of a close-up view of a bending waveguide 600, according to embodiments of the present disclosure. The bending waveguide 600 described herein corresponds to any of the plurality of bending waveguides 106 of the optical device 100 as described in FIG. 1A.

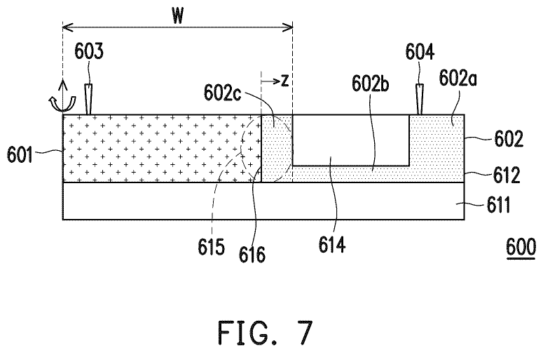

FIG. 7 illustrates a diagram of a cross-section view of the bending waveguide 600 along line R-R′ of FIG. 6, according to embodiments of the present disclosure.

In some embodiments, as shown in FIG. 6, the bending waveguide 600 is a ridge waveguide which includes a first doped portion 601 and a second doped portion 602 to form a P/N junction. In some embodiments, the first doped portion 601 is positioned inside of a concave curvature of the bending waveguide 600, and the second doped portion 602 is positioned outside of the concave curvature of the bending waveguide 600.

In some embodiments, as shown in FIG. 7, the bending waveguide 600 further includes a first electrical contact 603 on the first doped portion 601 and a second electrical contact 604 on the second doped portion 602. In some embodiments, a bias voltage is applied through the first electrical contact 603 and the second electrical contact 604 to the P/N junction at an interface 616 between the first doped portion 601 and the second doped portion 602. The bias voltage is applied to the P/N junction, such that a depletion region forms within the bending waveguide 600. The size of the depletion region changes when the bias voltage changes, thereby changing the effective refractive index of the bending waveguide 600 and the phase shift between the first optical signal 20 in the first waveguide arm 104 and the second optical signal 30 in the second waveguide arm 105. The modulation of the phase shift between the first optical signal 20 in the first waveguide arm 104 and the second optical signal 30 in the second waveguide arm 105 further modulates the output signal 60. In some embodiments, the bias voltage is in a range from about 0 volts to about 0.7 volts. In some embodiments, the bias voltage is in a range from greater than 0 volts to about 0.3 volts.

In some embodiments, when the phase shift between the first optical signal 20 in the first waveguide arm 104 and the second optical signal 30 in the second waveguide arm 105 is 180° (or an odd number times of 180°), the first phase-shifted optical signal 40 and the second phase-shifted optical signal 50 are destructively interfered. In some embodiments, when the phase shift between the first optical signal 20 in the first waveguide arm 104 and the second optical signal 30 in the second waveguide arm 105 is 360° (or an even number times of 180°), the first phase-shifted optical signal 40 and the second phase-shifted optical signal 50 are constructively interfered.

In some embodiments, the bending waveguide 600 is a portion of a circular waveguide. In some embodiments, the bending waveguide 600 is any suitable curved waveguide that is not necessarily circular-shaped. Such suitable curved waveguides do not have sharp corners and/or other features that can cause relatively high optical losses in some embodiments. In some embodiments, a radius of the circular waveguide ranges from about 1 μm to about 30 μm. If the radius of the circular waveguide is too small, signal loss increases as a result of a number of reflections as the optical signal propagates through the circular waveguide, in some instances. If the radius of the circular waveguide is too large, the overall size of the bending waveguide increases without an appreciable increase in performance, in some instances.

In some embodiments, the bending waveguide 600 includes an oxide layer 611 and a semiconductor layer 612 on the oxide layer 611. In some examples, the oxide layer 611 is a silicon oxide layer. In some examples, the semiconductor layer 612 is a silicon layer, a germanium layer, or a silicon germanium layer.

In some embodiments, as shown in FIG. 7, the semiconductor layer 612 includes the first doped portion 601 and the second doped portion 602 to form the P/N junction.

In some embodiments, the first doped portion 601 has a first dopant type and the second doped portion 602 has a second dopant type. The first dopant type is the opposite of the second dopant type. In some examples, the first doped portion 601 has an n-type dopant and the second doped portion 602 has a p-type dopant. Alternatively, in some examples, the first doped portion 601 has a p-type dopant and the second doped portion 602 has an n-type dopant.

In some embodiments, the bending waveguide 600 further includes an isolation layer 614 formed in a trench of the second doped portion 602. In some embodiments, the isolation layer 614 is a shallow trench isolation (STI) layer. The isolation layer 614 prevents electric current leakage between the second doped portion 602 and adjacent other semiconductor device components (not shown). In some embodiments, the isolation layer 614 is made of silicon oxide and/or silicon nitride.

In some embodiments, the second doped portion 602 includes a no-pickup section 602a, a waveguide section 602c, and a slab section 602b positioned between the no-pickup section 602a and the waveguide section 602c. In some embodiments, the isolation layer 614 is formed on the slab section 602b of the second doped portion 602.

In some embodiments, the first doped portion 601 and the waveguide section 602c of the second doped portion 602 form a ridge for the ridge waveguide. The P/N junction is formed by the first doped portion 601 and the waveguide section 602c of the second doped portion 602.

The optical mode in the bending waveguide 600 shifts in a direction z towards an outside of the curvature of the bending waveguide. For example, as shown in FIG. 7, optical mode 615 shifts away from an interface 616 between the first doped portion 601 and the second doped portion 602 in the direction z towards the outside of the curvature of the bending waveguide 600.

As shown in FIG. 7, when the optical mode 615 in the bending waveguide 600 shifts in the direction z towards an outside of the curvature of the bending waveguide 600, no slab section is needed in the first doped portion 601 to confine the optical mode 615. As a result, the parasitic resistance of the bending waveguide 600 may be reduced without causing any optical loss or optical mode confinement issue.

In some embodiments, a width W of the bending waveguide 600 varies along the curvature of the bending waveguide 600. The width W of the bending waveguide 600 changes slowly and gradually. In some embodiments, the bending waveguide 600 has an adiabatic changing curvature. The adiabatic changing curvature further reduces the parasitic resistance of the bending waveguide 600 without introducing more optical loss.

In some embodiments, the optical mode 615 formed in the bending waveguide 600 is a whispering-gallery mode, such that the optical signal travels around the inside concave surface of the bending waveguide 600. As a result, the energy distribution of the optical signal is shifted towards the inside concave surface and no slab section is needed in the first doped portion 601 to confine the optical mode 615.

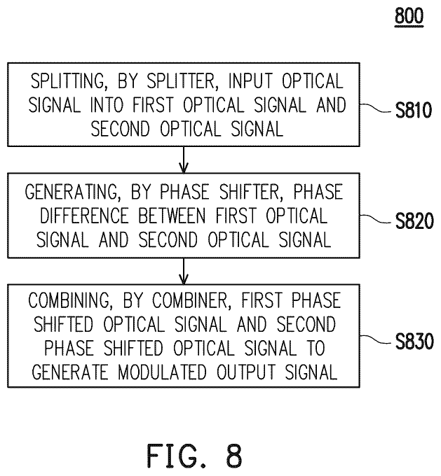

FIG. 8 illustrates a process flow 800 of operating the optical device 100, according to embodiments of the disclosure. For example, as shown in operation 810 of FIG. 8, the input optical signal is split by the splitter 101 into a first optical signal 20 and a second optical signal 30.

In some embodiments, as shown in operation 820 of FIG. 8, a phase difference is generated by the phase shifter 102, between the first optical signal 20 and the second optical signal 30. The phase shifter 102 includes a first waveguide arm 104 and a second waveguide arm 105, and each of the first waveguide arm 104 and the second waveguide arm 105 includes a plurality of bending waveguides 106 coupled in series. The first optical signal 20 is phase shifted in the first waveguide arm 104, and the second optical signal 30 is phase shifted in the second waveguide arm 105.

In some embodiments, as shown in operation 830 of FIG. 8, the first phase shifted optical signal 40 and the second phase shifted optical signal 50 are combined by a combiner to generate a modulated output signal 60.

The novel optical device according to the present disclosure provides an improved phase shifter that modulates an optical signal by using bending waveguides with P/N junctions, thereby improving the modulation efficiency of the optical device and reducing the signal loss during the modulation compared to conventional techniques and configurations. Embodiments of the disclosure further provide an improved optical device with a bending waveguide having asymmetric bent hybrid slabs to reduce the parasitic resistance and the overall size of the optical device, thereby improving the modulation efficiency of the optical device and reducing the signal loss during the modulation. Consequently, the modulation of optical signals can be improved, thereby enabling high-speed data communication for optical devices.

An embodiment of the disclosure is an optical device, including a splitter configured to split an input optical signal into a first optical signal and a second optical signal, and a phase shifter including a first waveguide arm and a second waveguide arm. Each of the first waveguide arm and the second waveguide arm includes a plurality of bending waveguides coupled in series, and the phase shifter is configured to generate a phase difference between the first optical signal in the first waveguide arm and the second optical signal in the second waveguide arm. The optical device further includes a combiner configured to combine the first optical signal and the second optical signal to generate a modulated output signal. In one embodiment, each of the plurality of bending waveguides includes an oxide layer and a semiconductor layer on the oxide layer. The semiconductor layer includes a first doped portion and a second doped portion to form a P/N junction at an interface between the first doped portion and the second doped portion. In one embodiment, the first doped portion and the second doped portion have opposite dopant types. In one embodiment, each of the first doped portion and the second doped portion includes a no-pickup section, a waveguide section, and a slab section positioned between the no-pickup section and the waveguide section. In one embodiment, each of the plurality of bending waveguides further includes a first isolation layer formed on the slab section of the first doped portion, and a second isolation layer formed on the slab section of the second doped portion. In one embodiment, a thickness of the slab section of the first doped portion equals a thickness of the slab section of the second doped portion. In one embodiment, the first doped portion is positioned inside of a curvature of each of the plurality of bending waveguides and the second doped portion is positioned outside of the curvature of each of the plurality of bending waveguides, and a thickness of the slab section of the first doped portion is greater than a thickness of the slab section of the second doped portion. In one embodiment, each of the plurality of bending waveguides includes electrical contacts, and electrical contacts are configured to provide a bias voltage to modulate a phase shift of the first optical signal in the first waveguide arm and a phase shift of the second optical signal in the second waveguide arm, respectively. In one embodiment, each of the first waveguide arm and the second waveguide arm includes a plurality of straight waveguides. Adjacent bending waveguides of the plurality of bending waveguides in each of the first waveguide arm and the second waveguide arm are coupled with each other through a corresponding straight waveguide of the plurality of straight waveguides. In one embodiment, each of the plurality of straight waveguides includes an oxide layer and a semiconductor layer on the oxide layer. The semiconductor layer includes a first doped portion and a second doped portion to form a P/N junction. In one embodiment, each of the plurality of bending waveguides has an adiabatic changing curvature.

Another embodiment of the disclosure is an optical device, including a first waveguide arm and a second waveguide arm. Each of the first waveguide arm and the second waveguide arm includes a plurality of bending waveguides coupled in series. The optical device is configured to generate a phase difference between a first optical signal in the first waveguide arm and a second optical signal in the second waveguide arm. Each of the plurality of bending waveguides includes an oxide layer and a semiconductor layer on the oxide layer. The semiconductor layer includes a first doped portion and a second doped portion to form a P/N junction.

Another embodiment of the disclosure is a method for modulating an input optical signal. The method includes splitting, by a splitter, the input optical signal into a first optical signal and a second optical signal, and generating, by a phase shifter, a phase difference between the first optical signal and the second optical signal. The phase shifter includes a first waveguide arm and a second waveguide arm, and each of the first waveguide arm and the second waveguide arm includes a plurality of bending waveguides coupled in series. The first optical signal is phase shifted in the first waveguide arm, and the second optical signal is phase shifted in the second waveguide arm. The method further includes combining, by a combiner, the first phase shifted optical signal and the second phase shifted optical signal to generate a modulated output signal.

Another embodiment of the disclosure is an optical device, including a first waveguide arm and a second waveguide arm. Each of the first waveguide arm and the second waveguide arm includes a plurality of bending waveguides coupled in series. The optical device is configured to generate a phase difference between a first optical signal in the first waveguide arm and a second optical signal in the second waveguide arm. The plurality of bending waveguides of each of the first waveguide arm and the second waveguide arm are oriented with convex sides facing in opposite directions, alternatively.

The foregoing outlines features of several embodiments or examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments or examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An optical device, comprising:
a splitter configured to split an input optical signal into a first optical signal and a second optical signal;
a phase shifter including a first waveguide arm and a second waveguide arm, wherein each of the first waveguide arm and the second waveguide arm includes a plurality of bending waveguides coupled in series, and the phase shifter is configured to generate a phase difference between the first optical signal in the first waveguide arm and the second optical signal in the second waveguide arm; and
a combiner configured to combine the first optical signal and the second optical signal to generate a modulated output signal.

2. The optical device according to claim 1, wherein each of the plurality of bending waveguides includes:
an oxide layer; and
a semiconductor layer on the oxide layer, wherein the semiconductor layer includes a first doped portion and a second doped portion to form a P/N junction at an interface between the first doped portion and the second doped portion.

3. The optical device according to claim 2, wherein the first doped portion and the second doped portion have opposite dopant types.

4. The optical device according to claim 2, wherein each of the first doped portion and the second doped portion includes a no-pickup section, a waveguide section, and a slab section positioned between the no-pickup section and the waveguide section.

5. The optical device according to claim 4, wherein each of the plurality of bending waveguides further includes:
a first isolation layer formed on the slab section of the first doped portion, and
a second isolation layer formed on the slab section of the second doped portion.

6. The optical device according to claim 4, wherein a thickness of the slab section of the first doped portion equals a thickness of the slab section of the second doped portion.

7. The optical device according to claim 4, wherein:
the first doped portion is positioned inside of a curvature of each of the plurality of bending waveguides and the second doped portion is positioned outside of the curvature of each of the plurality of bending waveguides, and
a thickness of the slab section of the first doped portion is greater than a thickness of the slab section of the second doped portion.

8. The optical device according to claim 2, wherein:
each of the plurality of bending waveguides includes electrical contacts, and
electrical contacts are configured to provide a bias voltage to modulate a phase shift of the first optical signal in the first waveguide arm and a phase shift of the second optical signal in the second waveguide arm, respectively.

9. The optical device according to claim 1, wherein each of the first waveguide arm and the second waveguide arm includes a plurality of straight waveguides, wherein adjacent bending waveguides of the plurality of bending waveguides in each of the first waveguide arm and the second waveguide arm are coupled with each other through a corresponding straight waveguide of the plurality of straight waveguides.

10. The optical device according to claim 9, wherein each of the plurality of straight waveguides includes:
an oxide layer; and
a semiconductor layer on the oxide layer, wherein the semiconductor layer includes a first doped portion and a second doped portion to form a P/N junction.

11. The optical device according to claim 1, wherein each of the plurality of bending waveguides has an adiabatic changing curvature.

12. An optical device, comprising:
a first waveguide arm; and
a second waveguide arm, wherein:
each of the first waveguide arm and the second waveguide arm includes a plurality of bending waveguides coupled in series,
the optical device is configured to generate a phase difference between a first optical signal in the first waveguide arm and a second optical signal in the second waveguide arm, and
each of the plurality of bending waveguides includes an oxide layer and a semiconductor layer on the oxide layer, wherein the semiconductor layer includes a first doped portion and a second doped portion to form a P/N junction.

13. The optical device according to claim 12, wherein each of the first doped portion and the second doped portion includes a no-pickup section, a waveguide section, and a slab section positioned between the no-pickup section and the waveguide section.

14. The optical device according to claim 13, wherein each of the plurality of bending waveguides further includes:
a first isolation layer formed on the slab section of the first doped portion, and
a second isolation layer formed on the slab section of the second doped portion.

15. The optical device according to claim 14, wherein a thickness of the slab section of the first doped portion equals a thickness of the slab section of the second doped portion.

16. The optical device according to claim 14, wherein:
the first doped portion is positioned inside of a curvature of each of the plurality of bending waveguides and the second doped portion is positioned outside of the curvature of each of the plurality of bending waveguides, and
a thickness of the slab section of the first doped portion is greater than a thickness of the slab section of the second doped portion.

17. The optical device according to claim 12, wherein:
each of the plurality of bending waveguides includes electrical contacts, and
the electrical contacts are configured to provide a bias voltage to modulate a phase shift of the first optical signal in the first waveguide arm and a phase shift of the second optical signal in the second waveguide arm, respectively.

18. A method for modulating an input optical signal, comprising:
splitting, by a splitter, the input optical signal into a first optical signal and a second optical signal;
generating, by a phase shifter, a phase difference between the first optical signal and the second optical signal, wherein the phase shifter includes a first waveguide arm and a second waveguide arm, each of the first waveguide arm and the second waveguide arm includes a plurality of bending waveguides coupled in series, the first optical signal is phase shifted in the first waveguide arm, and the second optical signal is phase shifted in the second waveguide arm; and
combining, by a combiner, the first phase shifted optical signal and the second phase shifted optical signal to generate a modulated output signal.

19. The method according to claim 18, wherein each of the plurality of bending waveguides includes:
an oxide layer; and
a semiconductor layer on the oxide layer, wherein the semiconductor layer includes a first doped portion and a second doped portion to form a P/N junction at an interface between the first doped portion and the second doped portion.

20. The method according to claim 19, wherein each of the plurality of bending waveguides includes electrical contacts, and the method further comprises:
providing, by the electrical contacts, a bias voltage for the P/N junction to modulate a phase shift of the first optical signal in the first waveguide arm and a phase shift of the second optical signal in the second waveguide arm, respectively.
